(19) United States
(12) Patent Application Publication
(10) Pub. No.: US 2015/0341594 A1
(43) Pub. Date: Nov. 26, 2015

(54) SYSTEMS AND METHODS FOR IMPLEMENTING MODEL-BASED QOE SCHEDULING

(71) Applicant: Vid Scale, Inc., Wilmington, DE (US)

(72) Inventors: Liangping Ma, San Diego, CA (US); Tianyi Xu, San Diego, CA (US); Gregory Sternberg, Mt. Laurel, NJ (US); Ariela Zeira, Huntington, NY (US); Anantharaman Balasubramanian, San Diego, CA (US); Avi Rapaport, Shoham (IL)

(21) Appl. No.: 14/442,073

(22) PCT Filed: Nov. 15, 2013
(86) PCT No.: PCT/US2013/070439

§ 371 Date: May 11, 2015

Related U.S. Application Data
(60) Provisional application No. 61/727,594, filed on Nov. 16, 2012.

(51) Int. Cl. H04N 7/14; H04N 7/15; H04W 28/02

(52) U.S. Cl. CPC H04N 7/147; H04W 28/0268; H04N 7/152

(57) ABSTRACT

Disclosed herein are systems and methods for implementing model-based quality-of-experience (QoE) scheduling. An embodiment takes the form of a method carried out by at least one network entity. The method includes receiving video frames from a video sender, which had first annotated each of the frames with a set of video-frame annotations including a channel-distortion model and a source distortion. The method also includes identifying all subsets of the received video frames that satisfy a resource constraint. The method also includes selecting, from among the identified subsets, based at least in part on the video-frame annotations, a subset that maximizes a QoE metric. The method also includes forwarding only the selected subset of the received video packets to a video receiver for presentation.

### RELATED APPLICATIONS

This application claims the benefit of pending priority application U.S. 61/727,594, filed Nov. 16, 2012, the entire contents of which are incorporated herein by reference.

### BACKGROUND

In recent years, networking technologies that provide higher throughput rates and lower latencies have enabled high-bandwidth and latency-sensitive applications such as video conferencing. The networks capable of hosting such applications may provide Quality of Service (QoS) support. However, the QoS metrics may not be adequate.

### OVERVIEW

Disclosed herein are systems and methods for implementing model-based quality-of-experience (QoE) scheduling.

An embodiment takes the form of a method carried out by at least one network entity. The at least one network entity includes a communication interface, a processor, and data storage containing instructions executable by the processor for carrying out the method, which includes receiving, via the communication interface and a communication network, video frames from a video sender, the video sender having first annotated each of the frames with a set of video-frame annotations, the set of video-frame annotations including a channel-distortion model and a source distortion. The method also includes identifying all subsets of the received video frames that satisfy a resource constraint. The method also includes selecting, from among the identified subsets, based at least in part on the video-frame annotations, a subset that maximizes a QoE metric. The method also includes forwarding, via the communication interface and the communication network, only the selected subset of the received video packets to a video receiver for presentation.

Another embodiment takes the form of a system that includes at least one network entity, which itself includes a communication interface, a processor, and data storage containing instructions executable by the processor for carrying out a set of functions, the set of functions including the functions recited in the preceding paragraph.

In at least one embodiment, selecting the subset of the received video frames that maximizes the QoE metric involves calculating, based at least in part on the video-frame annotations, a per-frame peak signal-to-noise ratio (PSNR) time series corresponding to each identified subset of received video frames, and further involves identifying the subset corresponding to the highest per-frame PSNR time series as the selected subset.

In at least one embodiment, the resource constraint relates to network congestion.

In at least one embodiment, the at least one network entity includes a router, a base station, and/or a Wi-Fi device.

In at least one embodiment, the video sender includes a user equipment and/or a multipoint control unit (MCU).

In at least one embodiment, the video sender also captured the video frames.

In at least one embodiment, the communication network includes a cellular network, a Wi-Fi network, and/or the Internet.

In at least one embodiment, the video sender annotates the frames in an Internet Protocol (IP) packet header extension and/or a Real-time Transport Protocol (RTP) packet header extension field.

In at least one embodiment, the channel-distortion model includes a channel-distortion prediction formula, a set of one or more characteristic features of a video-encoding process used in connection with the frame, a channel distortion, an error-propagation exponent, and/or a leakage value.

In at least one embodiment, the video-frame annotations indicate whether, with respect to the channel-distortion model, the intra macroblock refresh is cyclic or pseudo-random.

### BRIEF DESCRIPTION OF THE DRAWINGS

A more detailed understanding may be had from the following description, presented by way of example in conjunction with the accompanying drawings, wherein:

FIG. 1A depicts an example communications system in which one or more disclosed embodiments may be implemented;

FIG. 1B depicts an example wireless transmit/receive unit (WTRU) that may be used within the communications system of FIG. 1A;

FIG. 1C depicts an example radio access network (RAN) and an example core network that may be used within the communications system of FIG. 1A;

FIG. 1D depicts a second example RAN and a second example core network that may be used within the communications system of FIG. 1A;

FIG. 1E depicts a third example RAN and a third example core network that may be used within the communications system of FIG. 1A;

FIG. 1F depicts an example network entity that may be used within the communication system of FIG. 1A;

FIG. 2 depicts an example impact of a frame loss on the average PSNR of subsequent frames for the Foreman common intermediate format (Foreman-CIF) video sequence;

FIG. 3 depicts an example architecture of a video sender connected to a network;

FIG. 4A depicts an example per-frame PSNR prediction for a single frame loss;

FIG. 4B depicts an example per-frame PSNR prediction for two frame losses;

FIG. 5A depicts an example per-frame PSNR prediction error for a single frame loss;

FIG. 5B depicts an example per-frame PSNR prediction error for two frame losses with a gap of two frames in between;

FIG. 6 depicts an example mapping of a video frame through a protocol stack;

FIG. 7 depicts an example of random back-off range adjustment as a function of PSNR prediction loss; and

FIG. 8 depicts an example method in accordance with an embodiment.

### DETAILED DESCRIPTION

A detailed description of illustrative embodiments will now be provided with reference to the various Figures. Although this description provides detailed examples of possible implementations, it should be noted that the provided details are intended to be by way of example and in no way limit the scope of the application.

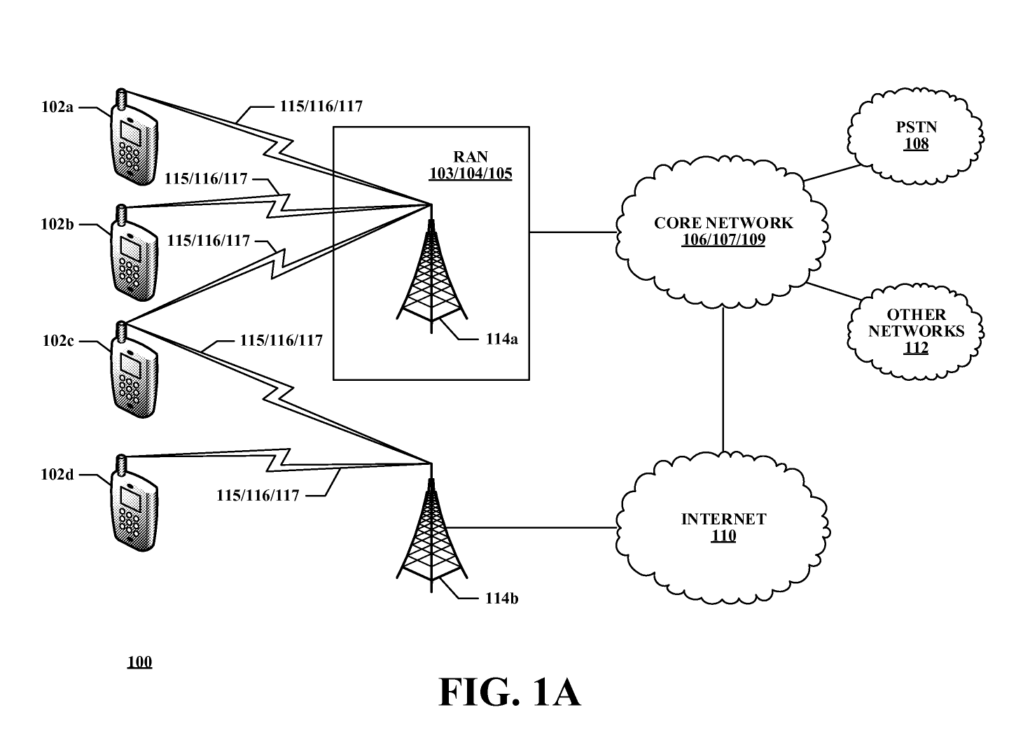

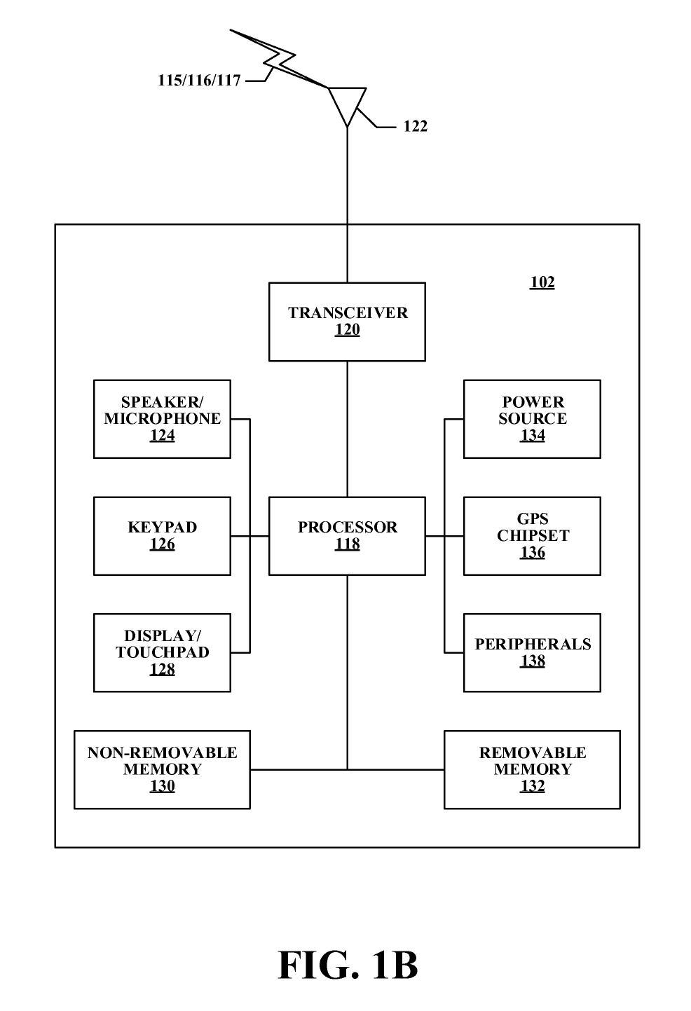

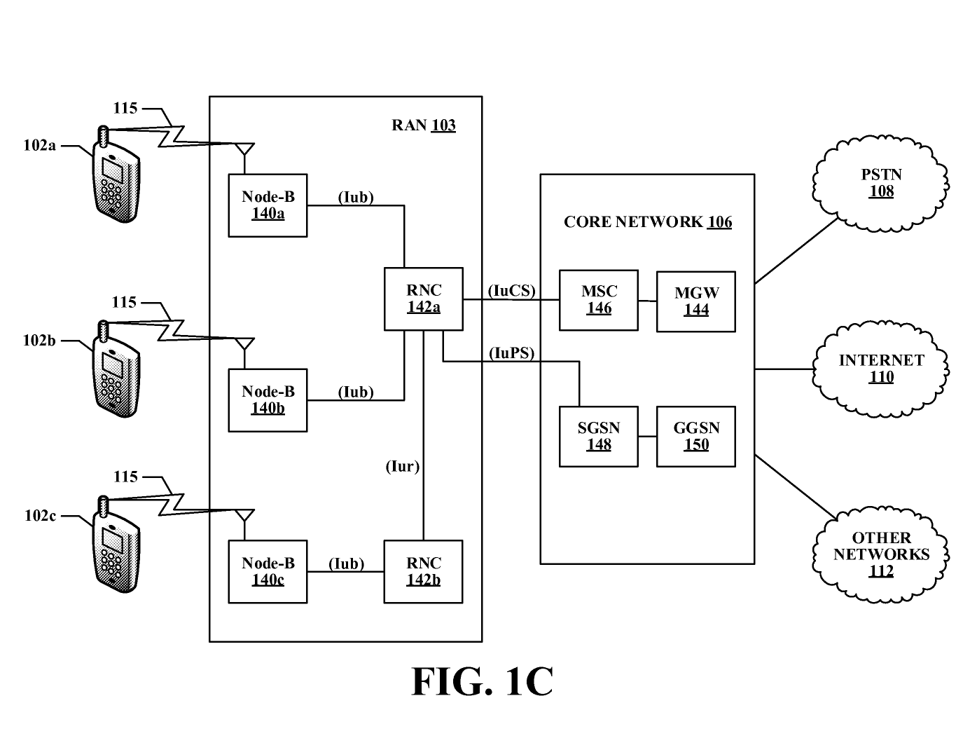

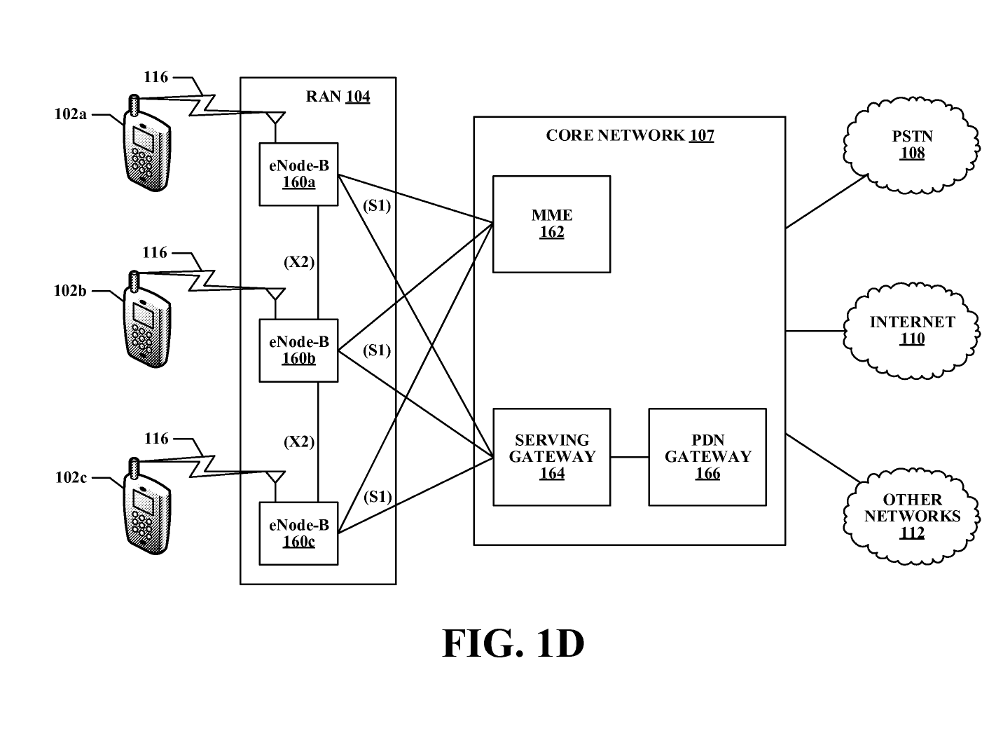

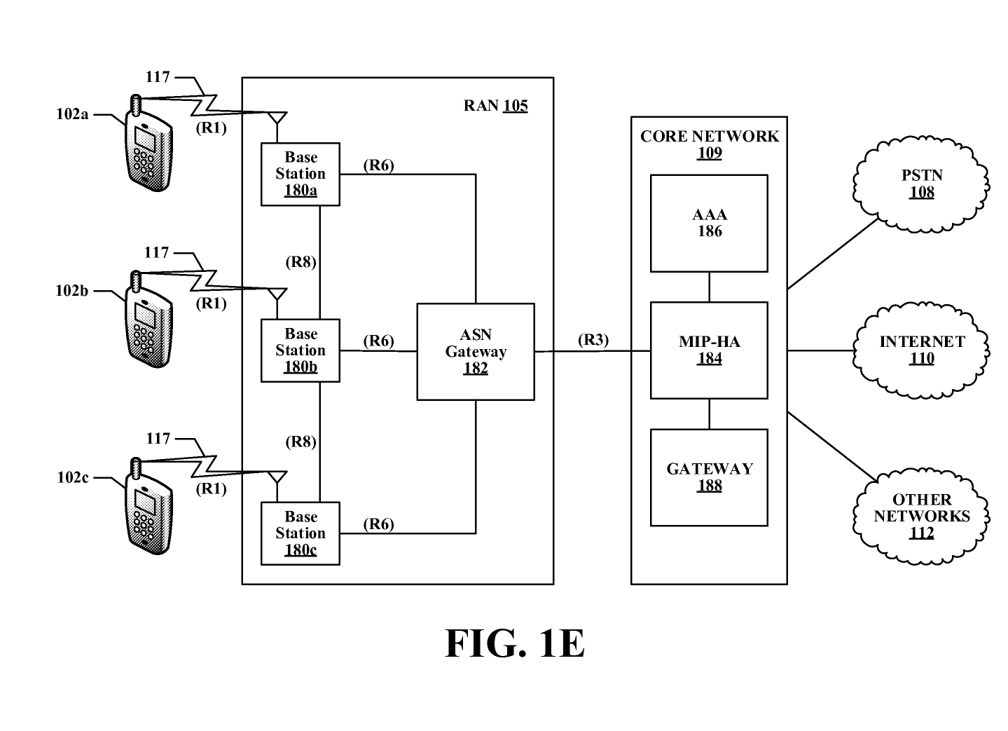

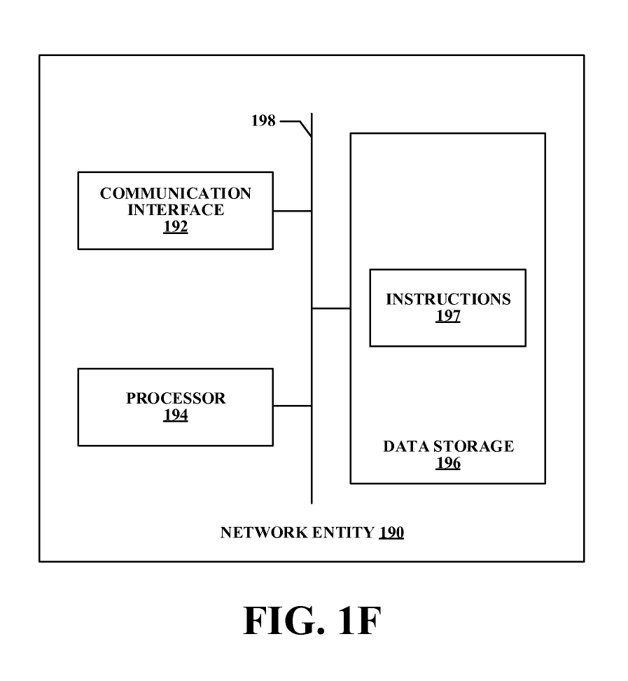

FIG. 1A is a diagram of an example communications system 100 in which one or more disclosed embodiments may be implemented. The communications system 100 may be a multiple access system that provides content, such as voice, data, video, messaging, broadcast, and the like, to multiple wireless users. The communications system 100 may enable multiple wireless users to access such content through the sharing of system resources, including wireless bandwidth. For example, the communications systems 100 may employ one or more channel-access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include WTRUs 102a, 102b, 102c, and/or 102d (which generally or collectively may be referred to as WTRU 102), a RAN 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, and the like. The base station 114a and/or the base station 114b may be configured to transmit and/or receive wireless signals within a particular geographic region, which may be referred to as a cell (not shown). The cell may further be divided into sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, and the like). The air interface 115/116/117 may be established using any suitable radio access technology (RAT).

More specifically, as noted above, the communications system 100 may be a multiple access system and may employ one or more channel-access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, as examples, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, and the like) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. As examples, the core network 106/107/109 may provide call control, billing services, mobile location-based services, pre-paid calling, Internet connectivity, video distribution, and the like, and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and IP in the TCP/IP Internet protocol suite. The networks 112 may include wired and/or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, a non-removable memory 130, a removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, as examples. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, as examples.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. As examples, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer-loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional landline communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between the WTRUs 102a, 102b, 102c and IP-enabled devices.

As noted above, the core network 106 may also be connected to the networks 112, which may include other wired and/or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio-resource-management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management entity (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an Si interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the Si interface. The serving gateway 164 may generally route and forward user data packets to/from the WTRUs 102a, 102b, 102c. The serving gateway 164 may also perform other functions, such as anchoring user planes during inter-eNode-B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional landline communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired and/or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility-management functions, such as handoff triggering, tunnel establishment, radio-resource management, traffic classification, quality-of-service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point (not shown), which may be used for authentication, authorization, IP-host-configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility-management capabilities, as examples. The core network 109 may include a mobile-IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA 184 may be responsible for IP-address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional landline communications devices. In addition, the gateway 188 may provide the WTRUs 102a, 102b, 102c with access to the networks 112, which may include other wired and/or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point (not shown), which may include protocols for coordinating the mobility of the WTRUs 102a, 102b, 102c between the RAN 105 and the other ASNs. The communication link between the core network 109 and the other core networks may be defined as an R5 reference point (not shown), which may include protocols for facilitating interworking between home core networks and visited core networks.

FIG. 1F depicts an example network entity 190 that may be used within the communication system 100 of FIG. 1A. As depicted in FIG. 1F, network entity 190 includes a communication interface 192, a processor 194, and non-transitory data storage 196, all of which are communicatively linked by a bus, network, or other communication path 198.

Communication interface 192 may include one or more wired communication interfaces and/or one or more wireless-communication interfaces. With respect to wired communication, communication interface 192 may include one or more interfaces such as Ethernet interfaces, as an example. With respect to wireless communication, communication interface 192 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 192 may be equipped at a scale and with a configuration appropriate for acting on the network side—as opposed to the client side—of wireless communications (e.g., LTE communications, Wi-Fi communications, and the like). Thus, communication interface 192 may include the appropriate equipment and circuitry (perhaps including multiple transceivers) for serving multiple mobile stations, UEs, or other access terminals in a coverage area.

Processor 194 may include one or more processors of any type deemed suitable by those of skill in the relevant art, some examples including a general-purpose microprocessor and a dedicated DSP.

Data storage 196 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art could be used. As depicted in FIG. 1F, data storage 196 contains program instructions 197 executable by processor 194 for carrying out various combinations of the various network-entity functions described herein.

In some embodiments, the network-entity functions described herein are carried out by a network entity having a structure similar to that of network entity 190 of FIG. 1F. In some embodiments, one or more of such functions are carried out by a set of multiple network entities in combination, where each network entity has a structure similar to that of network entity 190 of FIG. 1F. In various different embodiments, network entity 190 is—or at least includes—one or more of (one or more entities in) RAN 103, (one or more entities in) RAN 104, (one or more entities in) RAN 105, (one or more entities in) core network 106, (one or more entities in) core network 107, (one or more entities in) core network 109, base station 114a, base station 114b, Node-B 140a, Node-B 140b, Node-B 140c, RNC 142a, RNC 142b, MGW 144, MSC 146, SGSN 148, GGSN 150, eNode-B 160a, eNode-B 160b, eNode-B 160c, MME 162, serving gateway 164, PDN gateway 166, base station 180a, base station 180b, base station 180c, ASN gateway 182, MIP-HA 184, AAA 186, and gateway 188. And certainly other network entities and/or combinations of network entities could be used in various embodiments for carrying out the network-entity functions described herein, as the foregoing list is provided by way of example and not by way of limitation.

In real-time video applications such as video teleconferencing, the Intel® Integrated Performance Primitives (Intel® IPP or IPPP) video coding structure may be used, where the first frame may be an intra-coded frame, and each P frame may use the frame preceding it as a reference for motion-compensated prediction. To meet the stringent delay requirement, the encoded video may typically be delivered by the RTP/UDP protocol, which may be lossy in nature. When a packet loss occurs, the associated video frame, as well as subsequent frames, may be affected. This is often referred to as error propagation. Packet-loss information may be fed back to the video sender (or MCU, herein “video sender”), which may perform transcoding, via protocols such as RTP Control Protocol (RTCP) to trigger the insertion of an intra-coded frame to stop error propagation. The feedback delay, however, may at least be a round trip time (RTT). To alleviate error propagation, macroblock intra refresh, e.g., encoding some macroblocks of each video frame in the intra mode, may be used.

A video frame may be mapped into one or multiple packets (or slices in the case of H.264/AVC (Advanced Video Coding)). For low-bit-rate video teleconferencing, however, since the frame sizes are relatively small, the mapping may be one-to-one.

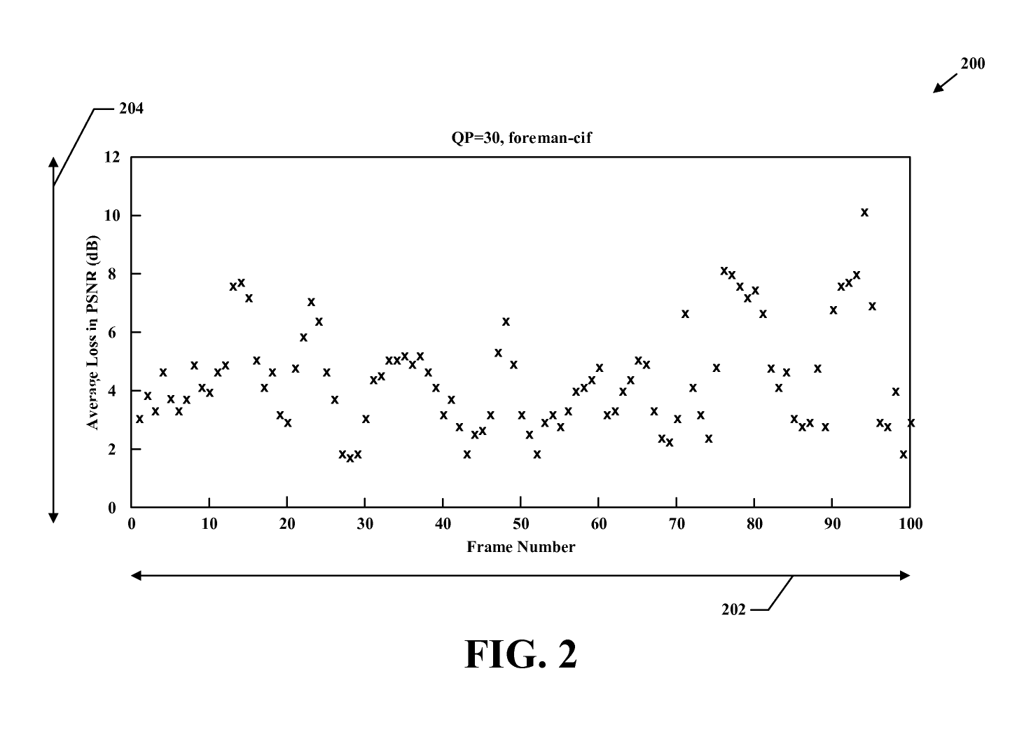

Although there may be no difference in the video-coding scheme for the P frames, the impact of a frame loss may be different from frame to frame. FIG. 2 illustrates, for example, an average loss in PSNR for the subsequent frames if a P frame is dropped in the network for the Foreman-CIF sequence encoded in H.264/AVC with a quantization parameter (QP)=30. It can be seen in FIG. 2 that the graph 200 includes a horizontal axis 202 denoting “Frame Number” from 0 through 100, and further includes a vertical axis 204 denoting “Average Loss in PSNR (in dB)” from 0 through 12, and that this may present an opportunity for a communication network to intelligently drop certain video packets in the event of, e.g., network congestion to, e.g., optimize the video quality.

A goal of network-resource allocation for video is to improve quality of the video as perceived by a user. To determine a video QoE, a QoE prediction scheme with low computational complexity and communication overhead may be utilized that may enable a network to allocate network resources to, e.g., improve and/or optimize the QoE. With such a scheme, the network may know the resulting video quality for each possible resource-allocation option (e.g., dropping certain frames in the network). The network may perform resource allocation by selecting an option based on video quality, e.g., corresponding to the best video quality. The network may predict the video quality before the video receiver performs video decoding. In making a resource-allocation decision, the network may predict the impact on QoE of the dropping of frames using a QoE metric that is amenable to analysis and control, such as an objective QoE metric constructed from the per-frame PSNR time series. The video sender and the communication network may jointly implement the QoE-prediction scheme. Simulation results of such a system have indicated per-frame PSNR prediction with an average error of less than 1 dB.

An additive and exponential model may be used with respect to channel distortion. Determination of the model may require some information, such as the motion reference ratio, about the predicted video frames to be known a priori. This may be possible if, for example, the encoder generates each of the video frames up to the predicted frame, though this may introduce a delay. For example, to predict the channel distortion 10 frames from a given instant in time, assuming 30 frames per second, the delay may be 333 ms. A model taking into account the cross-correlation among multiple frame losses may be used for channel distortion due to error propagation; in the parameter estimation, however, it may be necessary to know the complete video sequence in advance, which may make it infeasible for real-time applications. The video encoder may also use a pixel-level channel-distortion-prediction model. The complexity, however, may be high. Simpler prediction models, such as frame-level channel-distortion prediction for example, may therefore be desirable.

QoE metrics are related to video-quality-assessment methods, some of which are both subjective and able to reliably measure the video quality perceived by the human visual system (HVS). The use of subjective methods, however, typically requires playing the video to a group of human subjects in stringent testing conditions and collecting their ratings of the video quality. Subjective methods therefore tend to be time-consuming, expensive, and unable to provide real-time assessment results, and operate without predicting video quality. Objective methods that take into account the HVS can be used; these methods tend to approximate the performance of subjective methods.

In QoE prediction for video teleconferencing, which is real-time, many of the objective video-quality-assessment methods may not be applicable. As an example, the Video Quality Metric (VQM) may be a full-reference (FR) method, which may require access to the original video. Such a mechanism may, therefore, be infeasible in a communication network, making VQM unsuitable. As another example, the ITU recommendation G.1070, which is a no-reference (NR) method (i.e., one that may not access the original video), typically requires extensive subjective testing to construct a large number of QoE models offline. Such a method may require extracting certain video features, such as degree of motion, for example, during prediction in order to achieve desired accuracy, making this method unsuitable for real-time applications.

For QoE prediction within a communication network, it is desirable to use objective QoE metrics based on computable video-quality measures that are amenable to analysis and control. One such objective measure is PSNR. Statistics extracted from the per-frame PSNR time series form one example of a reliable QoE metric. Maximizing the average PSNR with a small PSNR variation may be performed, e.g., to optimize the video encoding for desired QoE. More specifically, the following calculations may be performed to determine a QoE metric: the first calculation is of certain statistics of the PSNR time series, such as the mean, the median, the 90 percentile, the 10 percentile, the mean of the absolute difference of the PSNR of adjacent frames, the 90 percentile of the absolute difference, and the like. These calculated statistics are then input into a model, such as the partial least square regression (PLSR) model, whose parameters have been determined based on a training phase. The output of the selected model may then be input into a nonlinear transformation having the desired range of values. The output from the nonlinear transformation may be mapped to standard QoE metrics such as the Mean Opinion Score (MOS), which will be the predicted QoE. With the use of such QoE metrics, QoE prediction may reduce to one that predicts the per-frame PSNR time series.

The pattern of packet losses may be considered because the video quality, or the statistics of the per-frame PSNR time series of a frame, may depend on factors including (i) the number of frame losses that have occurred and (ii) the place in the video sequence at which these frame losses have occurred.

Different approaches could be taken to QoE prediction. In a sender-only approach, the per-frame PSNR time series for each possible frame-loss pattern (i.e., each possible dropped-frame combination) could be obtained by simulation at the video sender. The number of possible frame-loss patterns, however, will tend to grow exponentially with the number of video frames. Even if the amount of computation were not an issue, the resulting per-frame PSNR time series, of which there may be an exponential number, would be sent to the communication network, tending to generate excessive communication overhead.

In a network-only approach, the network (e.g., a network entity or collection of cooperating network entities) could decode the video and determine the channel distortion for different potential frame-loss patterns (i.e., for different potential dropped-frame combinations). The video quality may depend on various factors, such as (i) the channel distortion and (ii) the distortion from source coding, as examples. Due to the lack of access to the original video, it may be difficult or impossible for the network to have or obtain information regarding the source distortion, which may make the QoE prediction inaccurate. This approach may not be scalable because, for example, the network may be handling a large number of video-teleconferencing sessions simultaneously. Furthermore, this approach may not be suitable when the video packets are encrypted.

A joint approach involves both the video sender and the network. The video sender may generate a channel-distortion model for single frame losses, for example, and may pass the results, along with the source distortion, to the network. The network may calculate the total distortion (and per-frame PSNR time series) by, e.g., utilizing the linearity and superposition assumption for multiple frame losses. The network may choose the frame-loss pattern to put into effect (i.e., choose the particular combination of frames to drop) based on PSNR time series (e.g., corresponding to the best per-frame PSNR time series). This approach avoids the excessive communication overhead of the sender approach and takes into account source distortion not considered by the network approach. And as compared with the sender approach and the network approach, the joint approach tends to reduce or even eliminate the use of video encoding or decoding in the network.

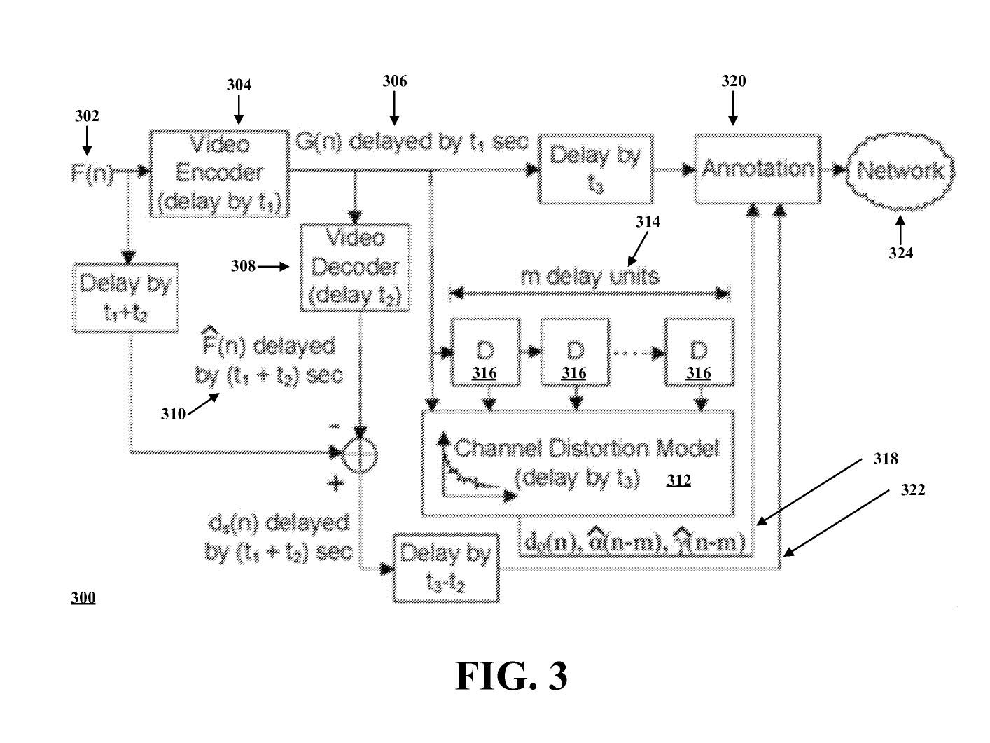

FIG. 3 illustrates an exemplary video sender 300 connected to a network. It is noted that, while FIG. 3 includes blocks having functional labels (such as the “Annotation” block 320), each such functional block may take the form of a module comprising hardware (e.g., one or more processors) executing instructions (e.g., software, firmware, and/or the like) for carrying out the described functions. Returning to FIG. 3, let the number of pixels in a frame be N. Let F(n), a vector of length N, be the nth original frame, and F(n, i) denote pixel i of F (n). Let \hat{F}(n) be the reconstructed frame without frame loss corresponding to F(n), and \hat{F}(n, i) be pixel i of \hat{F}(n).

As depicted in FIG. 3, original video frame F(n) 302 is fed into a video encoder 304, which generates an output packet G (n) 306 after a delay of t₁ seconds. The packet G (n) 306 may represent multiple NAL units, which may be referred to as a packet. Packet G (n) 306 may then be fed into a video decoder 308 to generate a reconstructed frame \hat{F}(n) 310 after a delay of t₂ seconds. Let the distortion due to source coding for F (n) be dₛ(n); dₛ(n) at the video encoder 304 may then be calculated as:

$${d}_{s} ( n ) = {\sum }_{i = 1}^{N} \frac{{( F ( n , i ) - \hat{F} ( n , i ) )}^{2}}{N} \qquad Equation ( 1 )$$

The construction of a channel-distortion model 312 may require some information (e.g., the motion reference ratio) of the predicted video frames to be known in advance, which may result in delay. The current packet G (n) 306 and the previously generated packets G (n−1), . . . , G (n−m) (where, as depicted in FIG. 3, m is the number of delay units 314 corresponding to the channel-distortion model 312) are used to train (i.e., calibrate) the channel-distortion model 312. In FIG. 3, D 316 represents a delay of an inter-frame time interval. The training may take t₃ seconds. Note that t₃ may be greater than or equal to t₂, because the channel-distortion model 312 may decode at least one frame. The values of the parameters for the model (i.e., {d₀(n), \hat{α}(n−m),\hat{γ}(n−m)}, as depicted in FIG. 3) are then sent (at 318) to an “Annotation” block 320 for annotation. As shown in FIG. 3, in an embodiment, the Annotation block 320 also annotates the source distortion dₛ(n) (communicated at 322). The annotated packet may be sent to the communication network 324. The video sender may also send additional information to the communication network 324, such as, as examples, (i) the channel-distortion prediction formula (such as that provided in Equation (4) below, as an example) and (ii) information related to the video-coding process being used (such as cyclic macroblock intra refresh and/or pseudo-random macroblock intra refresh, as examples). The channel-distortion prediction formula may be in the format, for example, of XML.

Furthermore, channel-distortion-model information may be provided. It may be the case that a linear and superposed model may perform in practice. For each possible frame loss being considered, an “impulse response” function h(k, l) can be defined; this impulse-response function may model how much distortion the loss of frame k would cause to frame l for l≧k, as shown in Equation (2) below:

$$h ( k , l ) = {d}_{0} ( k ) \frac{{e}^{- α ( k ) ( l - k )}}{1 + γ ( k ) ( l - k )} \qquad Equation ( 2 )$$

In Equation (2) above, d₀(k) represents the channel distortion for frame k that would result from the single loss of frame k and error concealment. As is described below, α(k) and γ(k) are parameters that are dependent on frame k.

Considering a simple error-concealment scheme, such as the frame copy for example, the distortion due to the loss of frame k (and only frame k) can be expressed as shown in Equation (3) below:

$${d}_{0} ( k ) = {\sum }_{i = 1}^{N} \frac{{( \hat{F} ( k , i ) - \hat{F} ( k - 1 , i ) )}^{2}}{N} \qquad Equation ( 3 )$$

In Equation (2), γ(k) can be referred to as leakage, describing the efficiency of loop filtering in removing artifacts introduced by motion compensation and transformation. The term e^{-α(k)(t-k)} captures the error propagation in the case of pseudo-random macroblock intra refresh. As an alternative to the term e^{-α(k)(t-k)}, a linear function (1−(1−k)β), where β is the intra refresh rate, could be used instead. Because the macroblock intra refresh scheme may be cyclic, a pseudo-random function may be preferred. The linear model may state that the impact may vanish after 1/β frames (the intra refresh update interval for the cyclic scheme), which may not be the case for the pseudo-random scheme. An exponential model, on the other hand, may fail to capture the impact of loop filtering. The values of α(k) and γ(k) may be obtained by methods such as “least squares” or “least absolute value” via fitting simulation data. As shown in FIG. 3, the video sender may drop packet G (n−m) from the packet sequence G (n), G (n−1), . . . , G (n−m), perform video decoding, measure the channel distortions, and determine a value for α(n−m) (defined as \hat{α}(n−m)) and a value for γ(n−m) (defined as \hat{γ}(n−m)) with the substitution k=n−m, which may minimize the error between the measured distortions and the predicted distortions.

The network may have packets G (n), G (n−1), . . . , G (n−L) available. 1(k), the indicator function, may be 1 if frame k is dropped, and 0 otherwise. A given packet-loss pattern may be characterized by a sequence of l(k)s. The pattern for a vector P may be denoted as: =(l(n), l(n−1), . . . , l(0)). The channel distortion of frame l≧n−L resulting from losing (i.e., dropping) P may be predicted as shown by Equation (4) below:

\hat{d}_{c}(l,P)=Σₖ₌₀^{l}l(k)\hat{h}(k,l) Equation (4)

where the linearity assumption for multiple frame losses may be used, and where:

$$\hat{h} ( k , l ) = {d}_{0} ( k ) \frac{{e}^{- α ( k - m ) ( l - k )}}{1 + γ ( k - m ) ( l - k )} \qquad Equation ( 5 )$$

The model in Equation (4) could be improved, for example, by including consideration of the cross-correlation of frame losses. Such a model may not be suitable for real time applications, however, as its complexity may be high. As shown in Equation (4), the model can be used without such considerations.

In order to predict the per-frame PSNR for a particular possible packet-loss pattern P, the network may need to have information regarding the source distortion. The total distortion prediction may be represented as shown in Equation (6) below:

\hat{d}(l,P)=d_{c}(l,P)+\hat{d}ₛ(l) Equation (6)

In Equation (6) above, \hat{d}ₛ(l)=dₛ(l) for n≧l≧(n−L), and \hat{d}ₛ (l)=dₛ(n) for l>n; furthermore, in connection with Equation (6), it can be assumed that the channel distortion and the source distortion are independent. The source distortion estimation \hat{d}ₛ(l) for n≧l>(n−L) may be precise and/or readily available at the video sender, and may be included in the annotation of the L+1 packets: G(n), G(n−1), . . . , G(n−L).

The PSNR prediction for frame l≧n−L in connection with the particular possible packet-loss pattern P may then be represented as shown in Equation (7) below:

$$( l , P ) = 10 {log}_{10} \frac{{255}^{2}}{\hat{d} ( l , P )} \qquad Equation ( 7 )$$

The per-frame PSNR time series is represented as { [symbol] (l, P)}, where l is the time index, and where the time series is a function of P. To generate a time series (e.g., a best time series), the network may choose P (e.g., the optimal P) from among those that are feasible in light of whatever resource constraint(s) (such as limited bandwidth and/or limited cache size, as examples) the network is subject to at that time. Further, part of P, such as {I(n−L−1), I(n−L−2), . . . , I(0)} as an example, may have been determined because, e.g., a frame between 0 and n−L−1 was either delivered or dropped, in which case the variables still subject to optimization would be the remaining part of P, (i.e., {I(n−L), . . . , I(n)}). The prediction length, λ, can be defined as the number of frames to be predicted. That is, if the nth frame is to be dropped, then the predictor may predict for {frame n, frame n+1, . . . , frame n+λ}.

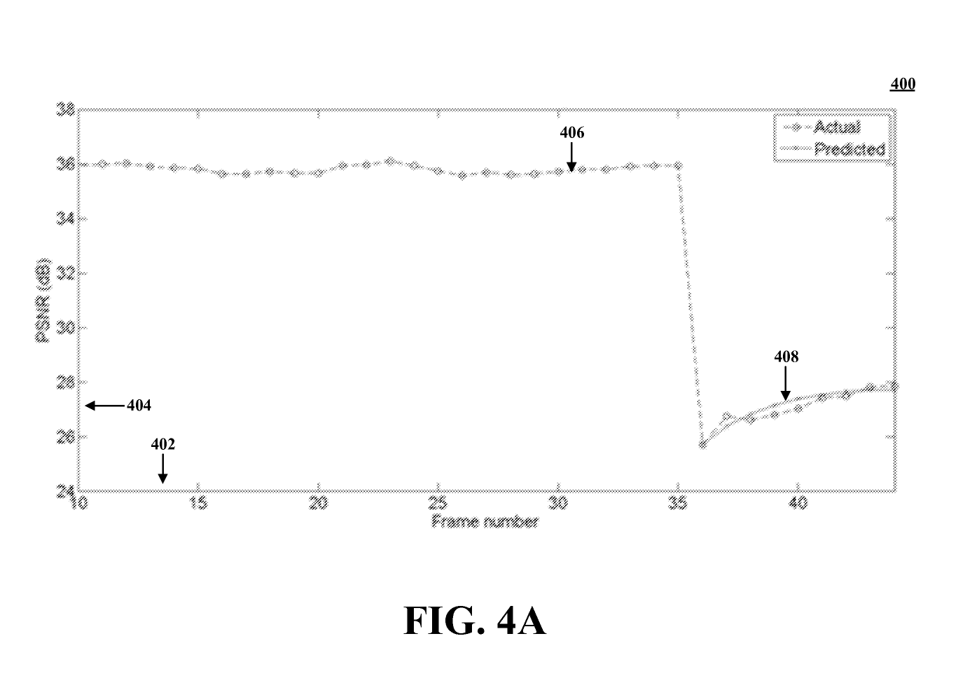

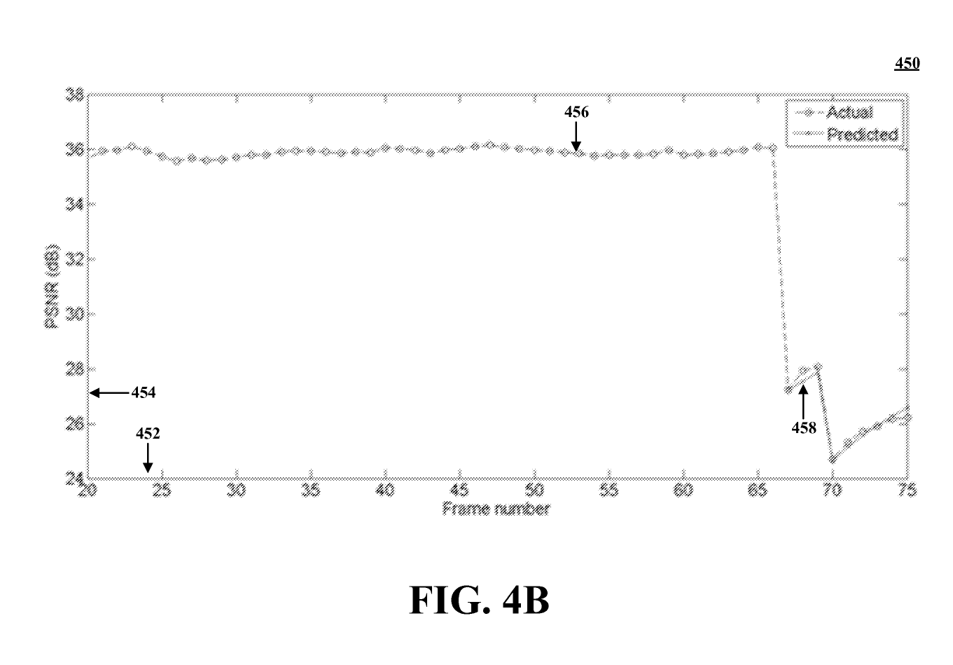

FIGS. 4A and 4B show simulation results for single frame losses and multiple frame losses in which the Foreman CIF video sequence was used. As can be seen in FIG. 4A, the depicted scenario 400 includes a horizontal axis 402 corresponding to “Frame number” 10 through 45, and further includes a vertical axis 404 corresponding to “PSNR (in dB)” from 24 to 38. Further, scenario 400 includes an “Actual” data series 406 as well as a “Predicted” data series (i.e., function, curve) 408. Moreover, as can be seen in FIG. 4B, the depicted scenario 450 includes a horizontal axis 452 corresponding to “Frame number” 20 through 75, and further includes a vertical axis 454 corresponding to “PSNR (in dB)” from 24 to 38. Further, scenario 450 includes an “Actual” data series 456 as well as a “Predicted” data series (i.e., function, curve) 458. For m=10, L=5, and λ=8, FIG. 4A illustrates the scenario 400 for frames l≧36 if frame 36 is dropped, and FIG. 4B illustrates the scenario 450 for frames l≧67 if frame 67 and frame 70 are dropped.

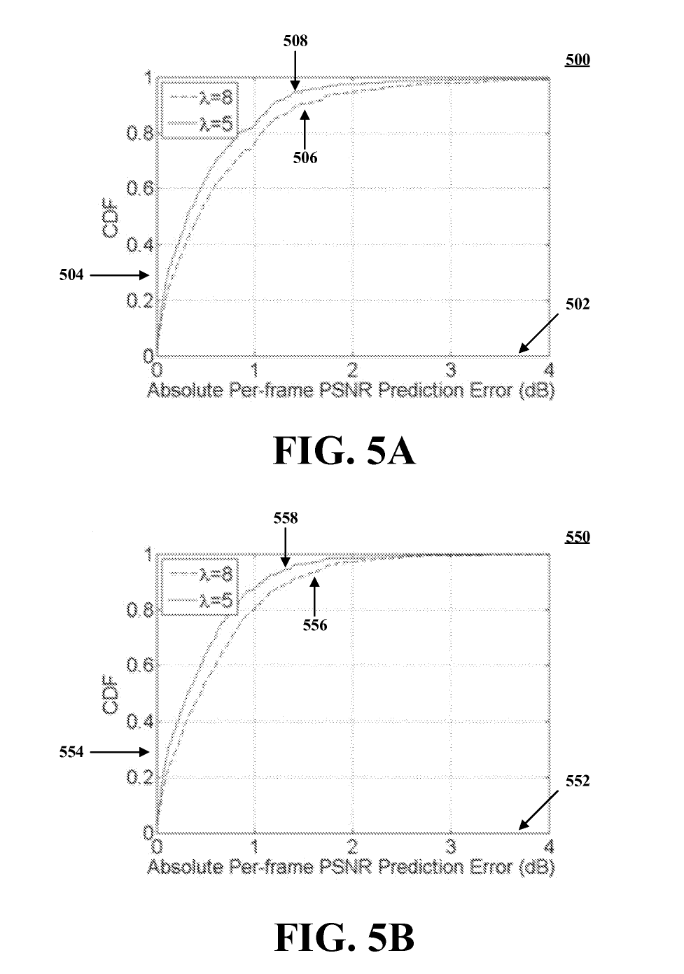

FIGS. 5A and 5B illustrate simulation scenarios and results (500 and 550), where dashed lines (506 and 556) correspond to a prediction length of 8, while solid lines (508 and 558) correspond to a prediction length of 5. In both FIGS. 5A and 5B, the horizontal axis (502 and 552) corresponds to “Absolute Per-frame PSNR Prediction Error (in dB)” from 0 through 4, while the vertical axis (504 and 554) corresponds to “CDF” (cumulative distribution function) from 0 through 1. FIG. 5A illustrates single frame losses, while FIG. 5B illustrates multiple frame losses, such as two frame losses with a gap of two frames in between, as an example. The CDF of the absolute prediction error (i.e., the absolute value of the difference between the actual per-frame PSNR and the predicted value) are plotted in dB. Moreover, it is also possible to calculate the mean value of the absolute prediction error. For single frame losses, the results were 0.66 dB and 0.51 dB for prediction lengths 8 and 5, respectively. For multiple frame losses, the results were 0.60 dB and 0.46 dB for prediction lengths 8 and 5, respectively.

An example of the QoE-prediction model for QoE-based network-resource allocation may be a queuing model where Q video frames (P frames) are buffered for transmission. Such a model may capture the essence of the logical channel buffer in, for example, LTE. Due to network congestion, a certain number of M video frames may be dropped. With the QoE prediction model, we may choose a combination of M out of Q frames to drop, e.g., such that dropping them may lead to the least video QoE degradation. In video teleconferencing, Q may typically be small in order to meet the delay requirement. For example, if the frame rate is 30 frames per second, Q frames may represent a delay of Q×33 ms. The total number of combinations to be considered may be relatively small. In case Q is large, lower complexity implementations may be used.

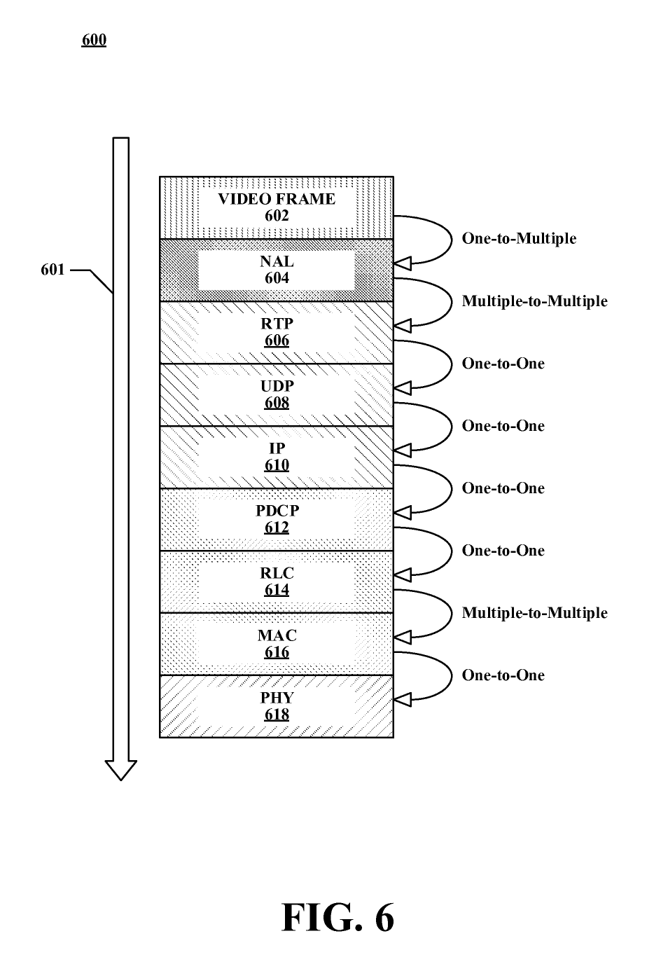

FIG. 6 illustrates a mapping 600 as a packet goes down the protocol stack. In particular, and by way of example, FIG. 6 shows the mapping 600 described and depicted in the direction of arrow 601. At the top of the depicted stack, each video frame 602 maps to multiple network abstraction layer (NAL) units 604. Multiple NAL units 604 map to multiple RTP packets 606. Each RTP packet 606 maps to one UDP datagram 608. Each UDP datagram 608 maps to one IP packet 610. Each IP packet 610 maps to one packet data convergence protocol (PDCP) packet 612. Each PDCP packet 612 maps to one radio link control (RLC) layer protocol data unit (PDU) 614. Multiple RLC PDUs 614 map to multiple media access control (MAC) layer frames 616. And each MAC-layer frame 616 maps to one physical-layer (PHY) frame 618. To determine the MAC-layer frames 616 corresponding to the same video frame 602, it may be possible to construct a look-up table locally to track the mapping. The mapping of video frames 602 into the NAL units 604 may be added.

The network in FIG. 3 may be a cellular network (WCDMA, LTE, and the like). The video sender may be a UE, a web camera on the Internet, and the like. The resource allocation decision may be made within the eNB. For the wireless uplink, part of the resource allocation decision may be implemented in the UE. The network in the FIG. 3 may be the Internet. The routers in that case may perform video quality driven active queue management (AQM). Traditional AQM schemes for example may focus on factors like throughput, delay, and may not consider the video. The QoE prediction model may, for example, be used for QoE based network resource allocation.

The per-frame PSNR prediction may be used in Wi-Fi systems, e.g., to optimize video quality of experience. Wi-Fi systems typically provide QoS policies that may be used when the offered traffic exceeds the capability of network resources; thus, QoS often provides predictable behavior for those occasions and points in the network where congestion is typically experienced. During overload conditions, QoS mechanisms typically grant some traffic priority, while making fewer resources available to lower-priority clients. Wi-Fi systems often use carrier-sense, multiple-access with collision avoidance (CSMA/CA) protocol to manage access to the wireless channel. Prior to transmitting a frame, CSMA/CA typically requires that a Wi-Fi device monitor the wireless channel for other Wi-Fi transmissions. If a transmission is in progress, the device typically sets a back-off timer to a random interval and then tries again when the timer expires. If the channel is clear, the device may wait a short interval—e.g., arbitration inter-frame space—before starting its transmission.

Since each device in a given group Wi-Fi devices is typically arranged to follow the same set of rules, CSMA/CA typically attempts to ensure “fair” access to the wireless channel for Wi-Fi devices. The Wi-Fi multimedia protocol (WMM) is sometimes used to adjust the random back-off timer according to the QoS priority of the frame to be transmitted.

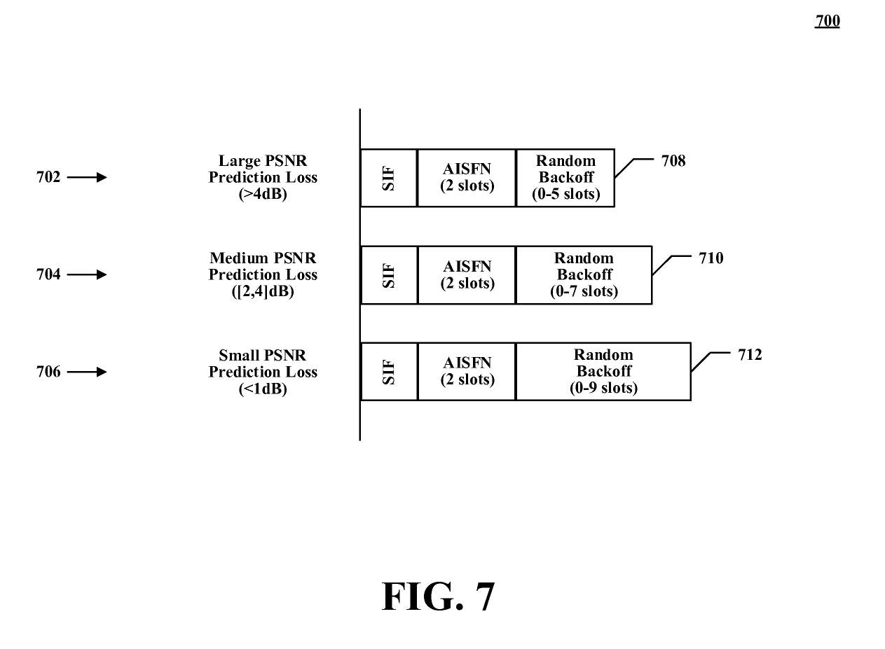

Similar concepts can be applied in the context of video transmission over Wi-Fi (e.g., to optimize such transmissions). The random back-off timer range may be adjusted based on video PSNR prediction mechanism that may examine the PSNR degradation due to future frame loss. For example, the larger the predicted PSNR loss due to, for example, transmission frame loss, the smaller the back-off timer range may be. FIG. 7 illustrates an example random back-off range adjustment as a function of PSNR prediction loss for video transmission. In particular, at 700, FIG. 7 depicts three different examples. At 702, for a relatively large PSNR prediction loss (such as greater than 4 dB), a random back-off range of 0-5 slots could be used. At 704, for a medium PSNR prediction loss (such as between 2 dB and 4 dB, inclusive), a random back-off range of 0-7 slots could be used. And as a third example, at 706, for a relatively small PSNR prediction loss (such as less than 1 dB), a random back-off range of 0-9 slots could be used. And clearly numerous other examples are possible, as these are provided for illustration and not by way of limitation.

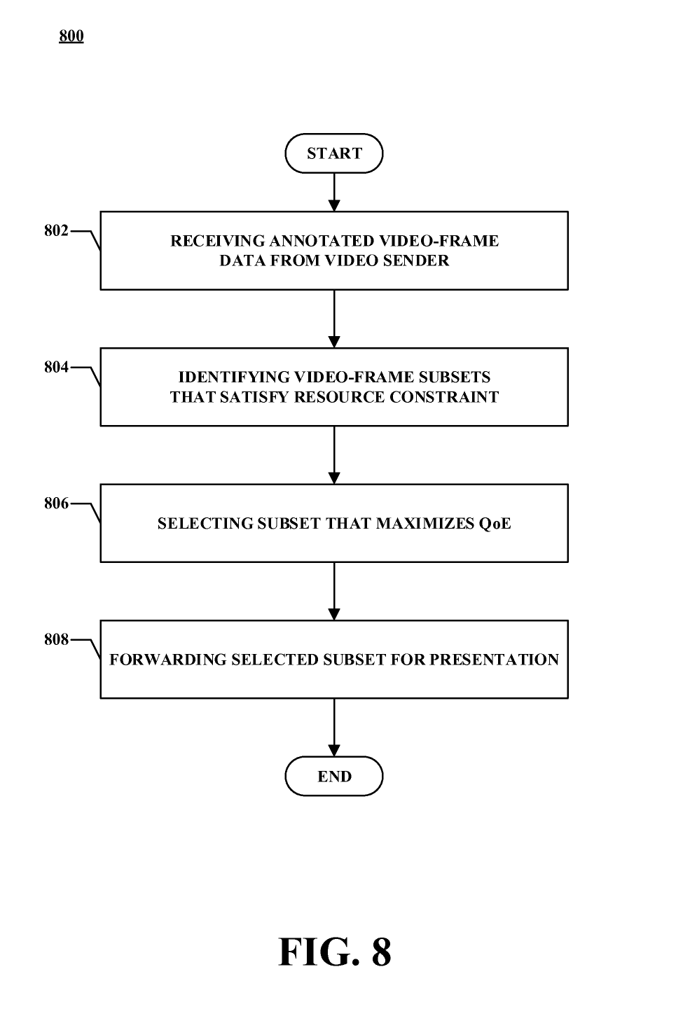

FIG. 8 depicts an example method 800 in accordance with an embodiment. In an embodiment, method 800 is carried out by network entity 190 of FIG. 1F. In at least one embodiment, network entity 190 includes a router, a base station, and/or a Wi-Fi device.

At 802, network entity 190 carries out the step of receiving, via communication interface 192 and a communication network, video frames from a video sender, where the video sender had first annotated each of the frames with a set of video-frame annotations, the set of video-frame annotations including a channel-distortion model and a source distortion. In at least one embodiment, the video sender includes a UE and/or a MCU. In at least one embodiment, the video sender also captured the video frames. In at least one embodiment, the communication network includes a cellular network, a Wi-Fi network, and/or the Internet. In at least one embodiment, the video sender annotates the frames in an IP packet header extension and/or an RTP packet header extension field. In at least one embodiment, the channel-distortion model includes a channel-distortion prediction formula, a set of one or more characteristic features of a video-encoding process used in connection with the frame, a channel distortion, an error-propagation exponent, and/or a leakage value. In at least one embodiment, the video-frame annotations indicate whether, with respect to the channel-distortion model, the intra macroblock refresh is cyclic or pseudo-random.

At 804, network entity 190 carries out the step of identifying all subsets of the received video frames that satisfy a resource constraint. In at least one embodiment, the resource constraint relates to network congestion.

At 806, network entity 190 carries out the step of selecting, from among the identified subsets, based at least in part on the video-frame annotations, a subset that maximizes a QoE metric. In at least one embodiment, step 806 involves calculating, based at least in part on the video-frame annotations, a per-frame PSNR time series corresponding to each identified subset of received video frames, and further involves identifying the subset corresponding to the highest per-frame PSNR time series as the selected subset.

At 808, network entity 190 carries out the step of includes forwarding, via communication interface 192 and the communication network, only the selected subset of the received video packets to a video receiver for presentation.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

We claim:

1. A method carried out by at least one network entity, the at least one network entity comprising a communication interface, a processor, and data storage containing instructions executable by the processor for carrying out the method, the method comprising:
receiving, via the communication interface and a communication network, video frame data from a video sender, the video frame data including a set of video-frame annotations, the set of video-frame annotations including at least one channel-distortion model parameter and a source distortion;
identifying subsets of the received video frames that satisfy a resource constraint;
selecting, from among the identified subsets, based at least in part on the video-frame annotations, a subset that maximizes a quality-of-experience (QoE) metric; and
forwarding, via the communication interface and the communication network, only the selected subset of the received video packets to a video receiver for presentation.

2. The method of claim 1, wherein selecting the subset of the received video frames that maximizes the QoE metric comprises:
calculating, based at least in part on the video-frame annotations, a per-frame peak signal-to-noise ratio (PSNR) time series corresponding to each identified subset of received video frames; and
identifying the subset corresponding to the highest per-frame PSNR time series as the selected subset.

3. The method of claim 1, wherein the resource constraint relates to network congestion.

4. The method of claim 1, wherein the at least one network entity comprises one or more network entities selected from the group consisting of a router, a base station, and a Wi-Fi device.

5. The method of claim 1, wherein the video sender comprises one or more video senders selected from the group consisting of a user equipment and a multipoint control unit (MCU).

6. The method of claim 1, the video sender having also captured the video frames.

7. The method of claim 1, wherein the communication network comprises one or more networks selected from the group consisting of a cellular network, a Wi-Fi network, and the Internet.

8. The method of claim 1, wherein the video sender annotates the frames in one or more headers selected from the group consisting of an Internet Protocol (IP) packet header extension and a Real-time Transport Protocol (RTP) packet header extension field.

9. The method of claim 1, wherein the channel-distortion model comprises one or more of a channel-distortion prediction formula, a set of one or more characteristic features of a video-encoding process used in connection with the frame, a channel distortion, an error-propagation exponent, and a leakage value.

10. The method of claim 1, wherein the video-frame annotations indicate whether, with respect to the channel-distortion model, the intra macroblock refresh is cyclic or pseudo-random.

11. A system comprising at least one network entity, the at least one network entity comprising:
a communication interface;
a processor; and
data storage containing instructions executable by the processor for carrying out a set of functions, the set of functions including:
receiving, via the communication interface and a communication network, video frames from a video sender, the video sender having first annotated each of the frames with a set of video-frame annotations, the set of video-frame annotations including a channel-distortion model and a source distortion;
identifying one or more subsets of the received video frames that satisfy a resource constraint;
selecting, from among the identified subsets, based at least in part on the video-frame annotations, a subset that maximizes a quality-of-experience (QoE) metric; and
forwarding, via the communication interface and the communication network, only the selected subset of the received video packets to a video receiver for presentation.

12. The system of claim 11, wherein selecting the subset of the received video frames that maximizes the QoE metric comprises:
calculating, based at least in part on the video-frame annotations, a per-frame peak signal-to-noise ratio (PSNR) time series corresponding to each identified subset of received video frames; and
identifying the subset corresponding to the highest per-frame PSNR time series as the selected subset.

13. The system of claim 11, wherein the resource constraint relates to network congestion.

14. The system of claim 11, wherein the at least one network entity comprises one or more network entities selected from the group consisting of a router, a base station, and a Wi-Fi device.

15. The system of claim 11, wherein the video sender comprises one or more video senders selected from the group consisting of a user equipment and a multipoint control unit (MCU).

16. The system of claim 11, the video sender having also captured the video frames.

17. The system of claim 11, wherein the communication network comprises one or more networks selected from the group consisting of a cellular network, a Wi-Fi network, and the Internet.

18. The system of claim 11, wherein the video sender annotates the frames in one or more headers selected from the group consisting of an Internet Protocol (IP) packet header extension and a Real-time Transport Protocol (RTP) packet header extension field.

19. The system of claim 11, wherein the channel-distortion model comprises one or more of a channel-distortion prediction formula, a set of one or more characteristic features of a video-encoding process used in connection with the frame, a channel distortion, an error-propagation exponent, and a leakage value.

20. The system of claim 11, wherein the video-frame annotations indicate whether, with respect to the channel-distortion model, the intra macroblock refresh is cyclic or pseudo-random.
